(19) United States
(12) Patent Application Publication
(10) Pub. No.: US 2026/0169473 A1
(43) Pub. Date: Jun. 18, 2026

(54) COMPROMISED STEERING DETECTION SYSTEM

(71) Applicant: Caterpillar Inc., Peoria, IL (US)

(72) Inventors: Andres MUNOZ-NAJAR, Mahomet, IL (US); Matthew D. JOHNSON, Dunlap, IL (US); Kunal SABOO, Washington, IL (US); Philip WALLSTEDT, Washington, IL (US); Sagar CHOWDHURY, Antioch, CA (US); Eric J. SCHULTZ, Metamora, IL (US); Emily A. MORRIS, Dunlap, IL (US)

(73) Assignee: Caterpillar Inc., Peoria, IL (US)

(21) Appl. No.: 18/983,895

(22) Filed: Dec. 17, 2024

(51) Int. Cl. G05B 23/02

(52) U.S. Cl. CPC G05B 23/0289; G05B 2223/02

(57) ABSTRACT

A method for operating an autonomous machine may include generating cross-track error (XTE) data corresponding to an operation of an autonomous machine over a period of time. The method may include identifying, from the XTE data, a first XTE peak during the period of time. Further, the method may include fitting a first composite sinusoidal half cycle to the first XTE peak; determining a first similarity score between the XTE data and the first composite sinusoidal half cycle; determining, based at least in part on the first similarity score, that a steering system of the autonomous machine has been compromised; and in response to determining that the steering system of the autonomous machine has been compromised, outputting at least one control command to stabilize the autonomous machine.

### TECHNICAL FIELD

The present disclosure relates generally to machine control systems, and more particularly, to methods and systems for detecting a compromised steering system.

### BACKGROUND

It is virtually impossible for a machine, whether manually or autonomously operated, to travel along an intended path without making any deviations from the intended path, however slight. To compensate for deviations from the intended path, at least minor steering adjustments may be regularly made during the operation of the machine as the machine travels along the intended path, or as close to the intended path as possible. For example, when a vehicle is being driven within a traffic lane, a driver of the vehicle may make minor steering adjustments to keep the vehicle as close to the center of the traffic lane as possible, however subconsciously. Or for example, when a machine is being autonomously piloted to a destination, minor imperfections of a steering system of the machine may cause the actual path of the machine to deviate slightly from the intended path of the machine, and an autonomous control system of the machine may make minor steering adjustments to compensate for the minor imperfections of the steering system.

Typically, minor steering adjustments made during the operation of a machine as the machine travels along an intended path, or as close to the intended path as possible, form a pattern that changes directions. As the machine deviates from the intended path to the left, a steering adjustment may be made to steer the machine to the right; as the machine deviates to the right, a steering adjustment may be made to steer the machine to the left. As a result, a comparison of an actual path of the machine to the intended path of the machine may appear sinusoidal. However, if the machine loses control, e.g., if a steering system of the machine becomes in some way compromised, deviations of the actual path of the machine from the intended path of the machine may become greater, longer, or compensated for less often. As a result, a comparison of the actual path of the machine to the intended path of the machine may appear increasingly sinusoidal as the machine increasingly loses control.

A method for detecting inattentive vehicle operation is disclosed in U.S. Patent Publication No. 2022/0292887A1 (the '887 application). The methods described in the '887 application include monitoring sinusoidal variations in the motion of a vehicle and comparing the sinusoidal variations in the motion of the vehicle with known patterns of motion that are indicative of inattentive driving. However, comparisons to inattentive driving patterns, such as those employing Fourier transforms, may produce false positives.

The methods and systems of the present disclosure may solve one or more of the problems set forth above or other problems in the art. The scope of the protection provided by the present disclosure, however, is defined by the attached claims, and not by the ability to solve any specific problem.

### SUMMARY

According to certain aspects of the disclosure, a method for operating an autonomous machine may include generating cross-track error (XTE) data corresponding to an operation of an autonomous machine over a period of time. The method may include identifying, from the XTE data, a first XTE peak during the period of time. Further, the method may include fitting a first composite sinusoidal half cycle to the first XTE peak; determining a first similarity score between the XTE data and the first composite sinusoidal half cycle; determining, based at least in part on the first similarity score, that a steering system of the autonomous machine has been compromised; and in response to determining that the steering system of the autonomous machine has been compromised, outputting at least one control command to stabilize the autonomous machine.

According to further aspects of the disclosure, a method for operating an autonomous machine may include generating machine speed data corresponding to an operation of an autonomous machine over a period of time. The method may include generating cross-track error (XTE) data corresponding to the operation of the autonomous machine over the period of time. Further, the method may include identifying, from the XTE data, a plurality of consecutive XTE peaks during the period of time; fitting a corresponding composite sinusoidal half cycle to each XTE peak of the plurality of consecutive XTE peaks; determining a similarity score between the XTE data and each XTE peak of the plurality of consecutive XTE peaks; determining, based at least in part on the machine speed data and the similarity scores determined for the plurality of consecutive XTE peaks, that a steering system of the autonomous machine has been compromised; and in response to determining that the steering system of the autonomous machine has been compromised, outputting at least one control command to stabilize the autonomous machine.

According to a further embodiment, a controller for an autonomous machine may include at least one processor and at least one memory storing instructions which, when executed by the at least one processor, cause the at least one processor to perform operations. The operations may include generating cross-track error (XTE) data corresponding to an operation of an autonomous machine over a period of time; identifying, from the XTE data, an XTE peak during the period of time; fitting a composite sinusoidal half cycle to the XTE peak; determining a similarity score between the XTE data and the composite sinusoidal half cycle; determining, based at least in part on the similarity score, that a steering system of the autonomous machine has been compromised; and in response to determining that the steering system of the autonomous machine has been comprised, outputting at least one control command to stabilize the autonomous machine.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary machine traversing an intended path;

FIG. 2 depicts a block diagram of an exemplary controller;

FIG. 3 depicts a chart representing an exemplary operation of a machine traversing an intended path;

FIG. 4 depicts a chart representing an exemplary operation of a machine traversing an intended path; and

FIG. 5 depicts a flowchart of an exemplary method for operating a machine.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Moreover, in this disclosure, relative terms, such as, for example, “about,” “substantially,” “generally,” and “approximately” are used to indicate a possible variation of ±10% in the stated value. In this disclosure, the term “based on,” or any other variation thereof, is intended to cover, for example, “partially based on”, “at least partially based on”, and “based entirely on”.

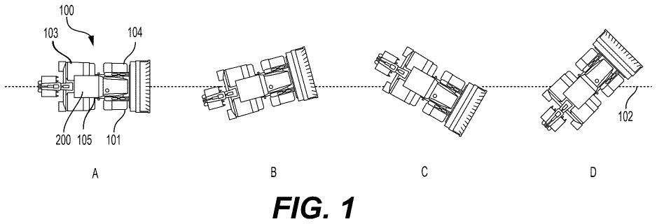

FIG. 1 depicts an exemplary machine 100 traversing an intended path 102. It will be understood and appreciated that the machine 100 may be any type of machine capable of traversing an intended path 102. For example, the machine 100 may be a passenger vehicle, or the machine 100 may be a work vehicle, as depicted in FIG. 1, such as an excavator or a large mining truck. The machine 100 may be manually operated, autonomously operated, or semi-autonomously operated. For example, the machine 100 may be an excavator operated by a human operator. Or for example, the machine 100 may be an autonomously operated excavator. Or for example, the machine 100 may be an excavator that is operated by a human operator when the excavator is performing excavation work, but autonomously operated when the excavator is traveling from one location to the next, or vice versa.

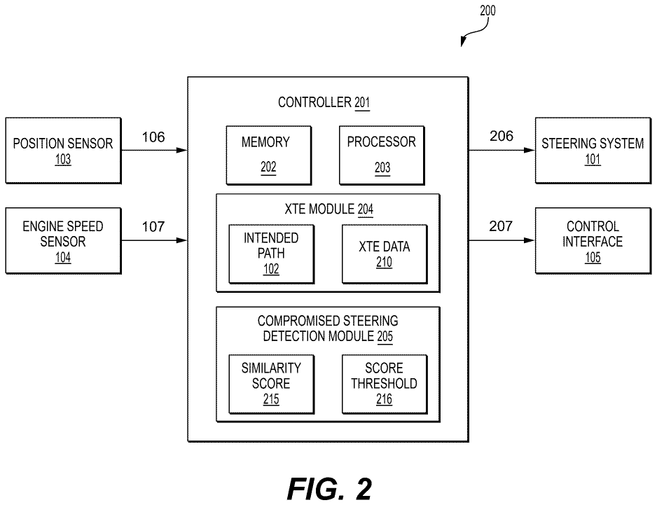

The machine 100 may include any components and systems necessary or appropriate for performing any function for which the machine 100 is employed. In particular, the machine 100 may include a steering system 101, a position sensor 103, an engine speed sensor 104, a control interface 105, and a compromised steering detection system (CSD) 200, which may include a controller 201 (FIG. 2). The steering system 101 may include any and all sensors, device, and systems appropriate for steering the machine 100 as the machine 100 traverses an intended path 102. For example, the steering system 101 may include an operator interface including a throttle pedal, a brake pedal, and a steering wheel. The steering system 101 may additionally or alternatively include an engine, a transmission, axles, wheels, tires, etc. The position sensor 103 may include any and all sensors, devices, or systems appropriate for determining a position of the machine 100 relative to the intended path 102. For example, the position sensor 103 may include a global positioning system (GPS) sensor, a radar system, a light detection and ranging (LiDAR) system, etc. The speed sensor 104 may include any and all sensors, device, or systems appropriate for determining a speed of the machine 100 as the machine 100 traverses the intended path 102. The control interface 105 may be on-board the machine 100 or off-board the machine 100, e.g., within a remote control center associated with the machine 100, and may include any appropriate means of communicating information regarding the machine 100 to an operator of the machine 100, such as an analog or digital display.

FIG. 2 depicts a block diagram of an exemplary compromised steering detection system (CSD) 200. As depicted in FIG. 2, the CSD 200 may include a controller 201, e.g., an electronic control module (ECM). The controller 201 may include a memory 202, a processor 203, or any other means for accomplishing a task or function consistent with the present disclosure. The memory 202 may store data or software configured to enable the processor 203 to perform various functions. In particular, the processor 203 may execute the instructions stored on the memory 202 to allow the controller 201 to perform any of the compromised steering detection functions described herein. Numerous commercially available processors or microprocessors can be configured to perform the functions of the controller 201. Various other known circuits may be associated with the controller 201, such as signal-conditioning circuitry, communication circuitry, or any other appropriate type of circuitry. As used herein, “controller” encompasses a single controller or multiple controllers operatively or communicatively coupled to one another or other components of the machine 100.

The controller 201 may include one or more modules configured to receive sensed inputs and generate commands or other signals to monitor or control the operation of one or more components or systems of the machine 100, e.g., the steering system 101. For example, the controller 201 may include a cross-track error (XTE) module 204 (e.g., instructions stored in memory accessible to the processor 203, e.g., the memory 202) configured to receive position data 106 from one or more position sensors 103 and generate, based on the position data 106 and an intended path 102 of the machine 100, XTE data 210 corresponding to an operation of the machine 100 over a period of time, as described in further detail below. Or for example, the controller 201 may include a compromised steering detection module 205 (e.g., instructions stored in memory accessible to the processor 203, e.g., the memory 202) configured to receive the XTE data 210 from the XTE module 204 or machine speed data 107 from one or more speed sensors 104 and determine, based on the XTE data 210 or the machine speed data 107, if the steering system 101 of the machine 100 has been compromised, as described in further detail below. As described in further detail below, the compromised steering detection module 205 may be configured to determine if the steering system 101 of the machine 100 has been compromised by using the XTE data 210 to determine a similarity score 215 and then comparing the similarity score 215 to a similarity score threshold 216. As described in further detail below, in response to determining that the steering system 101 of the machine 100 has been compromised, the controller 201 may be configured to output a control command 206 to the steering system 101 to stabilize the machine 100 or a compromised steering indication 207 to a control interface 105.

### Industrial Applicability

The systems, apparatuses, and methods disclosed herein may find application in any machine control system. In particular, the systems, apparatuses, and methods disclosed herein may be advantageously used in control systems for autonomously operated machines. Additionally, the systems, apparatuses, and methods disclosed herein may find application for system monitoring without any active machine control (e.g., an alarm or alert system).

As mentioned above, and as described in further detail below, the comprised steering detection system (CSD) 200 is capable of determining that a steering system 101 of a machine 100 has been compromised. In response to determining that the steering system 101 has been compromised, the CSD 200 may output a control command 206 to the steering system 101 to stabilize the machine 100 or a compromised steering indication to a control interface 105. For simplicity, in the examples described hereinafter, the machine 100 is autonomously operated. However, as mentioned above, it will be understood that the CSD 200 may be advantageously used in control systems for manually operated and autonomously operated machines alike.

FIG. 1 depicts an autonomous machine 100 traversing an intended path 102, e.g., a straight line from the left side of the depiction to the right side of the depiction. However, in this example, as the autonomous machine 100 progresses along the intended path 102 (e.g., from position A to position D), a steering system 101 of the autonomous machine 100 becomes compromised. For example, a wheel included in the steering system 101 may become misaligned, or a tire included in the steering system 101 may become deflated, each of which may cause the autonomous machine 100 to swerve, veer, or divert from the intended path 102. As depicted in FIG. 1, when the steering system 101 becomes compromised, the autonomous machine 100 initially deviates (e.g., from position A relative to intended path 102) to the left of the intended path 102 (e.g., to position B relative to intended path 102). A controller 201 of the autonomous machine 100 may detect the deviation to the left, e.g., by using position data 106 generated by a position sensor 103 of the autonomous machine 100 to determine an actual path of the autonomous machine 100 and comparing the actual path of the autonomous machine 100 to the intended path 102. In this example, in response to detecting the deviation to the left, the controller 201 attempts to compensate for the deviation to the left by outputting a control command 206 that causes the steering system 101 to steer the autonomous machine 100 to the right. However, because the steering system 101 is compromised, the autonomous machine 100 is steered to the right in a semi-controlled manner or in a way that overcompensates for the initial deviation to the left. As a result, instead of being brought back into alignment with the intended path 102 as intended, the autonomous machine 100 deviates to the right of the intended path 102 (e.g., to position C relative to intended path 102). The controller 201 may then detect the deviation to the right and again attempt to compensate for the deviation by outputting a control command 206 that causes the steering system 101 to steer the autonomous machine to the left. However, because the steering system 101 is compromised or because the previous attempt to compensate for the initial deviation to the left did not produce the intended result, the autonomous machine 100 is steered to the left in an even less controlled manner or in a way the further overcompensates for the deviation to the right (e.g., to position D relative to intended path 102). In this way, when the steering system 101 of the autonomous machine 100 is compromised, the controller 201 of the autonomous machine 100 may progressively lose control of the autonomous machine 100 or the actual path of the autonomous machine 100 may become progressively misaligned with the intended path 102.

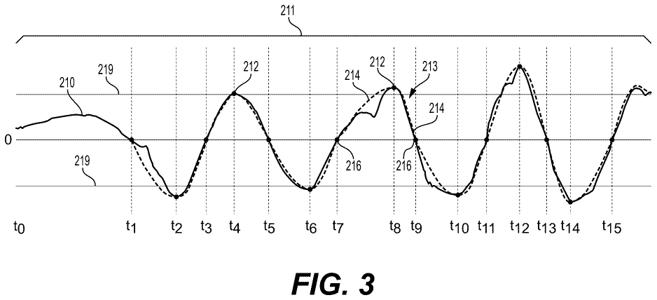

FIG. 3 depicts a chart representing an exemplary operation of an autonomous machine 100 traversing an intended path 102. As mentioned above, an autonomous machine 100 may include a position sensor 103 configured to generate position data 106. The controller 201 may generate or obtain the intended path 102 of the autonomous machine 100 in various ways. For example, in some instances, the intended path 102 of the autonomous machine 100 is generated by the controller 201 before the autonomous machine 100 traverses the intended path 102. Or for example, in some instances, the controller 201 may compile and/or process any and all control commands 206 outputted to the steering system 101 to generate the intended path 102 of the autonomous machine 100. Knowing the intended path 102 of the autonomous machine 100, a controller 201 of the autonomous machine 100 may use the position data 106 to determine an actual path of the autonomous machine 100. Using the actual path of the autonomous machine 100, the controller 201 may determine, at any point during the operation of the autonomous machine 100, a value or degree of deviation of the autonomous machine 100 from its intended path 102. For example, the controller 201 may determine how far to the left or to the right the autonomous machine 100 is from its intended path 102. The controller 201 may then generate cross-track error (XTE) data 210 by plotting the value or degree of the deviation of the autonomous machine 100 from its intended path 102 over a period of time 211, such as by employing the XTE module 204. For example, in the example depicted in FIG. 3, the XTE data 210 (depicted as a solid line) shows that the autonomous machine 100 is to the left of its intended path 102 between times t₀ and t₁, to the right of its intended path 102 between times t₁ and t₃, again to the left of its intended path 102 between times t₃ and t₅, etc.

As mentioned above, because it is virtually impossible for a machine 100 to travel along an intended path 102 without making at least minor deviations from the intended path 102, at least minor steering adjustments may be regularly made during the operation of the machine 100 to compensate for the at least minor deviations. However, as discussed above, if a steering system 101 of a machine 100 becomes comprised, the deviations of the machine 100 from its intended path 102 may be greater or less controlled. For example, in the example depicted in FIG. 3, when compared to the deviation of the autonomous machine 100 to the right of its intended path 102 between times t₁ and t₃, the deviation of the autonomous machine 100 to the left of its intended path 102 between times t₀ and t₁ is less severe and more even. This may indicate that a steering system 101 of the autonomous machine 100 became compromised at or around time t₁. As depicted in FIG. 3, because the deviations of the autonomous machine 100 may be greater or less controlled when the steering system 101 of the autonomous machine 100 is compromised, the XTE data 210 representing the operation of the autonomous machine 100 when the steering system 101 is compromised may appear more sinusoidal, e.g., the greater a similarity score 215 generated for a composite sinusoidal half cycle 213 fitted to the XTE data 210 may be, as described in further detail below. Indeed, the more compromised the steering system 101, the more sinusoidal the XTE data 210 may appear. A totally compromised or uncontrolled steering system 101 may produce nearly perfectly sinusoidal XTE data 210.

Accordingly, to determine if the steering system 101 of the autonomous machine 100 has become compromised, the controller 201 may determine the degree to which the XTE data 210 is sinusoidal, such as by employing the compromised steering detection module 205. In this example, to determine the degree to which the XTE data 210 is sinusoidal, the controller 201 first identifies a peak 212 in the XTE data 210 (hereinafter, an “XTE peak”). An XTE peak 212 may be identified at the time of the greatest deviation of the actual path of the autonomous machine 100 from its intended path 102 between any two consecutive inflection points 216. An inflection point 216 may be any point in time at which the deviation of the actual path of the autonomous machine 100 from its intended path 102 is equal to zero. For example, in the example depicted in FIG. 3, there is a first inflection point 216 at time t₁, a second and consecutive inflection point at time t₃, and a first XTE peak 212 between the first inflection point 216 and the second inflection point 216 at time t₂; there is a third inflection point 216 at time t₅ that is consecutive to the second inflection point 216 at time t₃ and a second XTE peak 212 between the second inflection point 216 and the third inflection point 216 at time t₄; etc. In some instances, the controller 201 identifies an XTE peak 212 only if an absolute value of the XTE peak 212 exceeds an XTE peak threshold 219.

After identifying an XTE peak 212, the controller 201 may fit a composite sinusoidal half cycle 213 to the XTE peak 212. A composite sinusoidal half cycle 213 may be a half sinusoid (e.g., the portion of a sine curve extending between two consecutive inflection points of the sine curve) formed by two or more sinusoidal components. For example, as depicted in FIG. 3, the controller 201 may fit a composite sinusoidal half cycle 213 (depicted as a dashed or broken line) to an XTE peak 212 by fitting a first sinusoidal quarter cycle 214 (e.g., the portion of a sine curve extending (i) from an inflection point of the sine curve to an immediately subsequent peak of the sine curve or (ii) from a peak of the sine curve to an immediately subsequent inflection point of the sine curve) from a first inflection point 216 to the XTE peak 212 and a second sinusoidal quarter cycle 214 from the XTE peak 212 to a second and consecutive inflection point 216. For example, in the example depicted in FIG. 3, a first composite sinusoidal half curve 213 has been fit to the XTE peak 212 at time t₂ by fitting a first sinusoidal quarter cycle 214 from a first inflection point 216 at time t₁ to the XTE peak 212 at time t₂ and fitting a second sinusoidal quarter cycle 214 from the XTE peak 212 at time t₂ to a second and consecutive inflection point 216 at time t₃; a second composite sinusoidal half cycle 213 has been fit to the XTE peak 212 at time t₄ by fitting a third sinusoidal quarter cycle 214 from the second inflection point 216 at time t₃ to the XTE peak 212 at time t₄ and fitting a fourth sinusoidal quarter cycle 214 from the XTE peak 212 at time t₄ to a third inflection point 216 at time t₅ that is consecutive to the second inflection point 216 at time t₃; etc. As depicted in FIG. 3, two sinusoidal quarter cycles 214 that form a composite sinusoidal half cycle 213 may not be symmetric; however, it will be understood and appreciated that two sinusoidal quarter cycles 214 that form a composite sinusoidal half cycle 213 may be substantially symmetric if the composite sinusoidal half cycle 213 is perfectly sinusoidal or nearly so. While a composite sinusoidal half cycle 213 is often described herein as being formed by two sinusoidal quarter cycles 214, the controller 201 may fit a composite sinusoidal half cycle 213 to an XTE peak 212 in any other way. For example, a composite sinusoidal half cycle 213 may be formed by any number of sinusoidal components, e.g., three sinusoidal components, four sinusoidal components, etc.

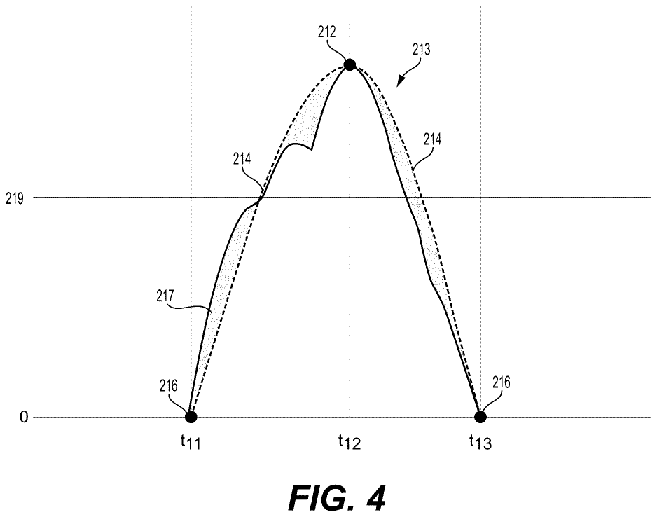

FIG. 4 depicts a chart representing an exemplary operation of an autonomous machine 100 traversing an intended path 102. In particular, FIG. 4 depicts the composite sinusoidal half cycle 213 fit to the XTE peak 212 at time t₁₂ in FIG. 3, as described above. After identifying an XTE peak 212 from XTE data 210 and fitting a sinusoidal half cycle 213 to the XTE peak 212, the controller 201 may determine a similarity score 215 between the composite sinusoidal half cycle 213 and the XTE data 210. To determine a similarity score 215 between a composite sinusoidal half cycle 213 and XTE data 210, the controller 201 may compare an area of the composite sinusoidal half cycle 213 with an area of the XTE data 210. For example, the controller 201 may determine (i) a first area between a) a zero line defined by a deviation value or degree of zero, e.g., the midline of composite sinusoidal half cycle 213, and b) the curve defined by the composite sinusoidal half cycle 213; and (ii) a second area between a) the portion of the zero line extending between the first inflection point 216 of the composite sinusoidal half cycle 213, e.g., the inflection point 216 at time t₁₁, and second inflection point 216 of the composite sinusoidal half cycle 213, e.g., the inflection point 216 at time t₁₃, and b) the curve defined by the XTE data 210. The controller 201 may then determine a similarity score 215 between the composite sinusoidal half cycle 213 and the XTE 210 by comparing the first area with the second area. It will be understood and appreciated that the controller 201 may compare the first area with the second area in various ways. For example, in some instances, the controller 201 compares the first area with the second area by (i) subtracting the smaller of the two areas from the larger of the two areas and (ii) dividing the result by the larger of the two areas to produce the similarity score 215, e.g., by calculating a percent difference between the first area and the second area. Or for example, in some instances, the controller 201 compares the first area with the second area by (i) identifying one or more interstitial areas 217 between the curve defined by the composite sinusoidal half cycle 213 and the curve defined by the XTE data 210, (ii) subtracting the sum total of the one or more interstitial areas 217 from the first area, and (iii) dividing the result by the first area to produce the similarity score 215. However, the controller 201 may determine a similarity score 215 between a composite sinusoidal half cycle 213 and XTE data 210 in any other appropriate way.

After identifying an XTE peak 212 from XTE data 210, fitting a composite sinusoidal half cycle 213 to the XTE peak 212, and determining a similarity score 215 between the composite sinusoidal half cycle 213 and the XTE data 210, the controller 201 may determine, based at least in part on the similarity score 215, whether a steering system 101 of an autonomous machine 100 has been compromised. It will be understood and appreciated that the controller 201 may determine whether a steering system 101 of an autonomous machine 100 has been compromised based at least in part on a similarity score 215 in various ways. For example, in some instances, the controller 201 determines whether a steering system 101 of an autonomous machine 100 has been compromised by comparing the similarity score 215 to a similarity score threshold 216. If the similarity score 215 exceeds the similarity score threshold 216, the controller 201 may determine that the steering system 101 of the autonomous machine 100 has been compromised. If the similarity score 215 does not exceed the similarity score threshold 216, the controller 201 may determine that the steering system 101 of the autonomous machine 100 has not been compromised. In some instances, the controller 201 determines whether a steering system 101 of autonomous machine has been compromised by comparing at least two similarity scores 215 determined for at least two respective and consecutive composite sinusoidal half cycles 213 to a similarity score threshold 216. If each of the at least two similarity scores 215 exceed the similarity score threshold 216, the controller 201 may determine that the steering system 101 of the autonomous machine 100 has been compromised. If any of the at least two similarity scores 215 does not exceed the similarity score threshold 216, the controller 201 may determine that the steering system 101 of the autonomous machine 100 has not been compromised.

In some instances, the controller 201 determines whether a steering system 101 of an autonomous machine 100 has been compromised based at least in part on a similarity score 215 and machine speed data 107 generated by a speed sensor 104 of the autonomous machine 100, as described above. For example, in some instances, the controller 201 determines whether a steering system 101 of an autonomous machine 100 has been compromised by (i) determining a similarity score threshold 216 based at least in part on machine speed data 107 generated by a speed sensor 104 of the autonomous machine 100 and (ii) comparing the similarity score 215 to the similarity score threshold 216 determined based at least in part on the machine speed data 107. If the similarity score 215 exceeds the similarity score threshold 216 determined based at least in part on the machine speed data 107, the controller 201 may determine that the steering system 101 of the autonomous machine 100 has been compromised. For example, the greater the speed indicated by the machine speed data 107, the lower the similarity score threshold 216 determined based at least in part on the machine speed data 107 may be, and vice versa. However, the controller 201 may determine whether a steering system 101 of an autonomous machine 100 has been compromised based at least in part on a similarity score 215 in any other appropriate way.

Accordingly, the controller 201, e.g., the compromised steering detection module 205, may determine whether a steering system 101 of an autonomous machine 100 has been compromised by employing a function of multiple variables. Such variables may additionally or alternatively include the peak values of XTE peaks 212, the durations of XTE peaks 212, the number of consecutive XTE peaks 212, the amount of time between consecutive XTE peaks 212, the similarity scores 215 determined for composite sinusoidal half cycles 213 fitted to XTE peaks 212, similarity score thresholds 216, machine speed data 107, or any other appropriate variables. For example, the function employed by the controller 201 may determine that a steering system 101 of an autonomous machine 100 has been compromised if each of at least three similarity scores 215 determined for at least three composite sinusoidal half cycles 213 fitted to at least three respective and consecutive XTE peaks 212 exceed a similarity score threshold 216, no matter what machine speed data 107 generated by a speed sensor 104 of the autonomous machine 100 may indicate. Or for example, the function employed by the controller 201 may determine that the steering system 101 of the autonomous machine 100 has been compromised if only a single similarity score 215 of a composite sinusoidal half cycle 213 fitted to an XTE peak 212 exceeds a similarity score threshold 216 if machine speed data 107 generated by the speed sensor 104 of the autonomous machine 100 indicates that the autonomous machine 100 is moving at a speed that exceeds a predetermined machine speed threshold, no matter what prior XTE data 210 indicates. Or for example, the function employed by the controller 201 may determine that the steering system 101 of the autonomous machine 100 has been compromised if the peak value of an XTE peak 212 exceeds a predetermined peak threshold, no matter what the similarity score 215 of a composite sinusoidal half cycle 213 fitted to the XTE peak 212 indicates. However, it will be understood and appreciated that the function employed by the controller 201 may determine if the steering system 101 of the autonomous machine 100 has been compromised in any other appropriate way.

In response to determining that a steering system 101 of an autonomous machine 100 has been compromised, the controller 201 may perform one or more actions. For example, in some instances, in response to determining that the steering system 101 of the autonomous machine 100 has been compromised, the controller 201 may output a compromised steering indication 207 to a control interface 105 associated with the autonomous machine 100, as described above. Such a compromised steering indication 207 may include a notification, such as a diagnostic message, transmitted for display via control interface 105 (which may be on-board the machine 100 or off-board the machine 100, e.g., within a remote control center associated with the machine 100) to indicate the machine should be directed to a workshop or repair site to address the steering system 101. Or for example, in some instances, in response to determining that the steering system 101 of the autonomous machine 100 has been compromised, the controller 201 may additionally or alternatively output a control command 206 to the steering system 101 to stabilize the autonomous machine 100. For example, the controller 201 may output a control command 206 that causes the steering system 101 of the autonomous machine 100 to slow or stop the autonomous machine 100.

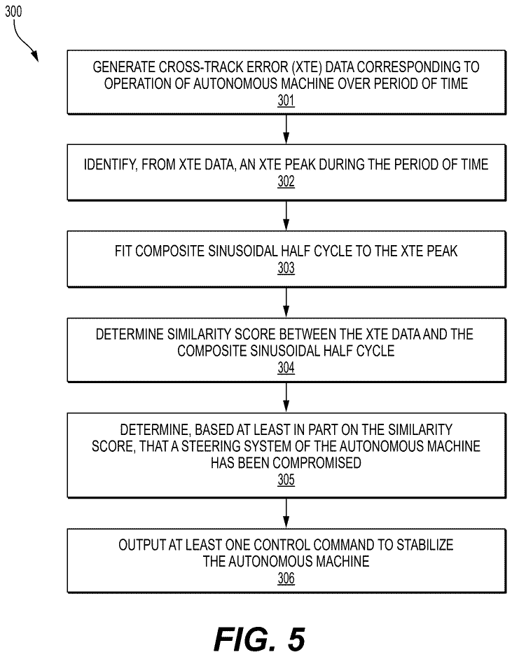

FIG. 5 depicts a flowchart of a method 300 for operating a machine 100 including a compromised steering detection system (CSD) 200. Method 300 may be performed repeatedly or at various times during the operation of the machine 100. For example, the method 300 may be performed at regular periodic intervals, upon operator request, when the machine 100 is moving at a machine speed exceeding a machine speed threshold, or upon detection of any appropriate data regarding the machine 100. In this way, a controller 201 of the machine 100 may save processing resources or improve resource utilization during the operation of the machine 100. Although the steps of the method 300 are depicted and described in a particular order, it will be understood and appreciated that any steps of the method 300 may be performed in any appropriate order, or simultaneously. For simplicity, in the examples described herein after, the machine 100 is an autonomous machine 100. However, as mentioned above, it will be understood and appreciated that the machine 100 may be manually operated, autonomously operated, or semi-autonomously operated.

In some instances, as depicted in FIG. 5, the method 300 may begin with a step 301, in which a controller 201 included in the CSD 200 generates cross-track error (XTE) data 210 corresponding to an operation of an autonomous machine 100 over a period of time 211. As described above, the controller 201 may generate XTE data 210 by 1) using position data 106 generated by a position sensor 103 of the autonomous machine 100 to determine an actual path of the autonomous machine 100 and 2) comparing the actual path of the autonomous machine 100 to an intended path 102 of the autonomous machine 100 to determine a value or degree of the deviation of the autonomous machine 100 from its intended path 102 at any point during the period of time 211.

In some instances, as depicted in FIG. 5, after the controller 201 generates the XTE data 210, the method 300 continues with a step 302, in which the controller 201 identifies, from the XTE data 210, an XTE peak 212 during the period of time 211. As described above, the controller 201 may identify an XTE peak 212 from the XTE data 210 by identifying the time of the greatest deviation of the actual path of the autonomous machine 100 from its intended path 102 between any two consecutive inflection points 216, e.g., a point in time at which the deviation of the actual path of the autonomous machine 100 from its intended path 102 is equal to zero.

In some instances, as depicted in FIG. 5, after the controller 201 identifies the XTE peak 212, the method 300 continues with a step 303, in which the controller 201 fits a composite sinusoidal half cycle 213 to the XTE peak 212. As described above, the controller 201 may fit a composite sinusoidal half cycle 213 to an XTE peak 212 by fitting a first sinusoidal half cycle 214 from a first inflection point 216, immediately prior to the XTE peak 212, to the XTE peak 212 and a second sinusoidal half cycle 214 from the XTE peak 212 to a second inflection point 216 immediately subsequent to the XTE peak 212.

In some instances, as depicted in FIG. 5, after the controller 201 fits the composite sinusoidal half cycle 213 to the XTE peak 212, the method 300 may continue with a step 304, in which the controller 201 determines a similarity score 215 between the composite sinusoidal half cycle 213 and the XTE data 210. As described above, the controller 201 may determine the similarity score 215 by 1) determining a) first area between a zero line and the curve defined by the composite sinusoidal half cycle 213 and b) a second area between the zero line and the curve defined by the XTE data 210 and 2) comparing the first area with the second area. As described above, the controller 201 may compare the first area with the second area in various ways, such as a by determining a percent difference between the first area and the second area or by identifying one or interstitial areas 217 between the first area and the second area and subtracting the sum total of the one or more interstitial areas 217 from the first area.

In some instances, as depicted in FIG. 5, after the controller 201 determines the similarity score 215, the method 300 may continue with a step 305, in which the controller 201 determines, based at least in part on the similarity score 215, whether a steering system 101 of the autonomous machine 100 has been compromised. As described above, the controller 101 may determine whether the steering system 101 of the autonomous machine 100 has been compromised based at least in part on the similarity score 215 in various ways, such as by comparing the similarity score 215 to a similarity score threshold 216. If the similarity score 215 exceeds the similarity score threshold 216, the controller 201 may determine that the steering system 101 of the autonomous machine 100 has been compromised. If the similarity score 215 does not exceed the similarity score threshold 216, the controller 201 may determine that the steering system 101 of the autonomous machine 100 has not been compromised.

In some instances, as depicted in FIG. 5, after the controller 201 determines in step 305 that the steering system 101 of the autonomous machine 100 has been compromised, the method 300 may continue with a step 306, in which the controller 201 outputs a control command 206 to the steering system 101 to stabilize the autonomous machine 100. As described above, in some instances, in response to determining that the steering system 101 of the autonomous machine 100 has been compromised, the controller 201 may additionally or alternatively output a compromised steering indication 207 to a control interface 105 associated with the autonomous machine 100.

By generating XTE data 210 and using the XTE data 210 to determine whether a steering system 101 of an autonomous machine 100 has been compromised, the CSD 200 may prevent an autonomous machine 100 from experiencing a catastrophic failure or prevent an autonomous machine 100 from harming or causing damage to people or things in the vicinity of the autonomous machine 100. By fitting composite sinusoidal half cycles 213 to XTE peaks 212 identified from the XTE data 210, the CSD 200 may avoid detecting false positive indications that the steering system 101 of the autonomous machine 100 has been compromised, which may improve the efficiency of the operation of the autonomous machine 100, particularly when compared to methods and systems for detecting compromised steering through the use of fast Fourier transforms.

It will be apparent to those skilled in the art that various modifications and variations can be made to the disclosed apparatuses, methods, and systems without departing from the scope of the disclosure. Other embodiments of the apparatuses, methods, and systems will be apparent to those skilled in the art from consideration of the specification and practice of the apparatuses, methods, and system disclosed herein. It is intended that the specification and examples be considered as exemplary only, with a true scope of the protection provided by the present disclosure being indicated by the following claims and their equivalents.

What is claimed is:

1. A method for operating an autonomous machine, the method comprising:
generating cross-track error (XTE) data corresponding to an operation of an autonomous machine over a period of time;
identifying, from the XTE data, a first XTE peak during the period of time;
fitting a first composite sinusoidal half cycle to the first XTE peak;
determining a first similarity score between the XTE data and the first composite sinusoidal half cycle;
determining, based at least in part on the first similarity score, that a steering system of the autonomous machine has been compromised; and
in response to determining that the steering system of the autonomous machine has been compromised, outputting at least one control command to stabilize the autonomous machine.

2. The method of claim 1, wherein generating the XTE data comprises:
identifying an intended path of autonomous machine over the period of time;
obtaining actual path data of the autonomous machine over the period of time;
comparing the actual path data of the autonomous machine to the intended path of the autonomous machine.

3. The method of claim 1, wherein fitting the first composite sinusoidal half cycle to the first XTE peak comprises fitting a first sinusoidal quarter cycle from a first inflection point to the first XTE peak and a second sinusoidal quarter cycle from the first XTE peak to a second inflection point.

4. The method of claim 1, wherein determining the first similarity score between the XTE data and the first composite sinusoidal half cycle comprises comparing a first area of the XTE data with a second area of the first composite sinusoidal half cycle.

5. The method of claim 1, wherein determining that the steering system has been compromised comprises determining that the first similarity score exceeds a similarity score threshold.

6. The method of claim 1, further comprising:
generating machine speed data corresponding to the operation of the autonomous machine over the period of time; and
determining that the steering system of the autonomous machine has been compromised based at least in part on the first similarity score and the machine speed data.

7. The method of claim 6, wherein determining that the steering system has been compromised comprises:
determining a similarity score threshold based on the machine speed data; and
determining that the first similarity score exceeds the similarity score threshold.

8. The method of claim 1, wherein outputting the at least one control command to stabilize the autonomous machine comprises outputting at least one control command to slow or stop the autonomous machine.

9. The method of claim 1, further comprising determining that an absolute value of the first XTE peak exceeds an XTE peak threshold.

10. The method of claim 1, further comprising:
identifying, from the XTE data, a second XTE peak during the period of time;
fitting a second composite sinusoidal half cycle to the second XTE peak;
determining a second similarity score between the XTE data and the second composite sinusoidal half cycle; and
determining that the steering system of the autonomous machine has been compromised based at least in part on the first similarity score and the second similarity score.

11. A method for operating an autonomous machine, the method comprising:
generating machine speed data corresponding to an operation of an autonomous machine over a period of time;
generating cross-track error (XTE) data corresponding to the operation of the autonomous machine over the period of time;
identifying, from the XTE data, a plurality of consecutive XTE peaks during the period of time;
fitting a corresponding composite sinusoidal half cycle to each XTE peak of the plurality of consecutive XTE peaks;
determining a similarity score between the XTE data and each XTE peak of the plurality of consecutive XTE peaks;
determining, based at least in part on the machine speed data and the similarity scores determined for the plurality of consecutive XTE peaks, that a steering system of the autonomous machine has been compromised; and
in response to determining that the steering system of the autonomous machine has been compromised, outputting at least one control command to stabilize the autonomous machine.

12. The method of claim 11, further comprising:
determining a similarity score threshold; and
determining that at least one XTE peak of the plurality of consecutive XTE peaks exceeds the similarity score threshold.

13. The method of claim 12, wherein the similarity score threshold is based at least in part on the machine speed data.

14. The method of claim 12, further comprising determining that each XTE peak of the plurality of consecutive XTE peaks exceeds the similarity score threshold.

15. The method of claim 11, wherein each composite sinusoidal half cycle fitted to a corresponding XTE peak of the plurality of XTE peaks comprises a first sinusoidal quarter cycle from a first inflection point to the XTE peak and a second sinusoidal quarter cycle from the XTE peak to a second inflection point.

16. A controller for an autonomous machine, the controller comprising at least one processor and at least one memory storing instructions which, when executed by the at least one processor, cause the at least one processor to perform operations comprising:
generating cross-track error (XTE) data corresponding to an operation of an autonomous machine over a period of time;
identifying, from the XTE data, an XTE peak during the period of time;
fitting a composite sinusoidal half cycle to the XTE peak;
determining a similarity score between the XTE data and the composite sinusoidal half cycle;
determining, based at least in part on the similarity score, that a steering system of the autonomous machine has been compromised; and
in response to determining that the steering system of the autonomous machine has been comprised, outputting at least one control command to stabilize the autonomous machine.

17. The controller of claim 16, wherein the operations further comprise:
generating machine speed data corresponding to the operation of the autonomous machine over the period of time;
determining a similarity score threshold based on the machine speed data; and
determining that the similarity score exceeds the similarity score threshold.

18. The controller of claim 16, wherein the operations further comprise determining that an absolute value of the XTE peak exceeds an XTE peak threshold.

19. The controller of claim 16, wherein the composite sinusoidal half cycle comprises a first sinusoidal quarter cycle from a first inflection point to the XTE peak and a second sinusoidal quarter cycle from the XTE peak to a second inflection point.

20. The controller of claim 16, wherein determining the similarity score between the XTE data and the composite sinusoidal half cycle comprises comparing a first area of the XTE data with a second area of the composite sinusoidal half cycle.
